(19) United States
(12) Patent Application Publication
(10) Pub. No.: US 2019/0214184 A1
(43) Pub. Date: Jul. 11, 2019

(54) INDUCTOR WITH COIL CONDUCTOR FORMED BY CONDUCTIVE MATERIAL

(71) Applicant: AJOHO ENTERPRISE CO., LTD., Taipei City (TW)

(72) Inventors: Chia-Ping MO, Taipei City (TW); You-Chi LIU, Taipei City (TW)

(21) Appl. No.: 16/357,832

(22) Filed: Mar. 19, 2019

Related U.S. Application Data
(63) Continuation-in-part of application No. 15/972,814, filed on May 7, 2018.

(30) Foreign Application Priority Data
Nov. 2, 2017 (TW) 106137962
Aug. 14, 2018 (TW) 107128336

(51) Int. Cl. H01F 27/28; H01F 27/24; H01F 1/03; H01F 1/147

(52) U.S. Cl. CPC H01F 27/2804; H01F 27/24; H01F 1/14708; H01F 1/0317; H01F 1/0315; H01F 27/2823

(57) ABSTRACT

An inductor with coil conductor formed by conductive material includes an insulative plastic block including a block base, a positioning unit with U-shaped plates mounted in the block base and conductors respectively formed of an electroplated conductive adhesive on the U-shaped plates using laser direct structuring (LDS) and isolated from one another, magnetic conductive components each including a magnetic core mounted in the base and defining therein slots for the passing of the U-shaped plates, and a connection carrier including a substrate and a wire array located on the substrate and electrically bonded with leads of the conductors to create with the magnetic cores a magnetic coil loop capable of providing a magnetic induction effect. Thus, the inductor of the invention has the advantages of simple structure, high production efficiency and cost effectiveness.

This application is a Continuation-In-Part of co-pending application Ser. No. 15/972,814, filed on May 7, 2018, for which priority is claimed under 35 U.S.C. § 120, the entire contents of which are hereby incorporated by reference.

This application claims the priority benefit of Application number 107128336, filed in Taiwan on Aug. 14, 2018 and Application number 106137962 filed in Taiwan on Nov. 2, 2017.

### BACKGROUND OF THE INVENTION

### 1. Field of the Invention

The present invention relates to magnetic technologies and more particularly, to an inductor with coil conductor formed by conductive material, which comprises an insulative plastic block comprising a block base, a positioning unit with U-shaped plates mounted in the block base and conductors respectively formed of an electroplated conductive adhesive on the U-shaped plates using laser direct structuring (LDS) and isolated from one another, magnetic conductive components each comprising a magnetic core mounted in the base and defining therein slots for the passing of the U-shaped plates, and a connection carrier including a substrate and a wire array located on the substrate and electrically bonded with leads of the conductors to create with the magnetic cores a magnetic coil loop capable of providing a magnetic induction effect.

### 2. Description of the Related Art

With the rapid growth of electronic technology, active components and passive components are widely used on internal circuit boards of electronic products. Active components (such as microprocessors or IC chips) can perform arithmetic and processing functions alone. However, passive components (such as resistors, capacitors and inductors, etc.) will maintain their resistance or impedance when the applied current or voltage is changed. In application, active components and passive components are used in information, communication and consumer electronic products to achieve electronic loop control subject to matching of circuit characteristics between components.

Further, an inductor is a passive two-terminal electrical component that stores electrical energy in a magnetic field when electric current flows through it. There are many types of inductors. Inductors often used as electromagnets and transformers are known as coil that can provide high resistance to high frequency. An inductor for use to block higher-frequency alternating current (AC) in an electrical circuit, while passing lower-frequency or direct current (DC) is often referred to as choke or choke ring. Large inductors used with ferromagnetic materials in transformers, motors and generators are called windings. Inductors according to the electromagnetic induction can be divided into self-induction and mutual induction. When the wire turns wound round the magnetic body (such as magnetic core or ferromagnetic material) increases, the inductance will also become larger. The number of wire turns, the area of the wire turns (loop) and the wire material will affect the inductance size.

An inductor typically consists of an insulated wire wound into a coil around a ferromagnetic magnetic core or a core material with a higher magnetic permeability than the air. When the current flowing through an inductor changes, the time-varying magnetic field induces a voltage in the conductor. However, in actual applications, conventional inductors still have drawbacks as follows:

(1) When the insulated wire is wound into a coil around the ferromagnetic magnetic core, uneven winding of the coil often occurs due to differences in manual winding distribution, and the stray capacitance on the inductor will be difficult to control, resulting in differences between the noise suppression capabilities of same specification coils. Thus, the exact distance between the coil windings must be controlled. Due to small core volume, the manual winding method takes a lot of man-hours. Further, manual winding is not practical for mass production so that the manufacturing cost cannot be reduced.

(2) In order to obtain a larger amount of inductance, the coil windings will generally be overlapped; however, the insulative layer of the enameled wire can easily be scratched during the winding process. Further, overlapping the coil windings of the insulated wire around the ferromagnetic magnetic core will greatly increase the dimension of the inductor; in sequence, the inductor will require a relatively larger circuit board mounting surface to affect the overall circuit layout. When bonding the leads of the coil of the inductor to a circuit board, the large volume of the coil can touch other electronic components on the circuit board, causing coil damage and affecting the electrical characteristics and charge and discharge functions of the inductor.

Therefore, how to solve the problem that the current inductor component is manually wound around the coil is time-consuming and labor-intensive, and cannot be mass-produced and costly, and the inductance component is bulky, occupies space on the circuit board, and affects the electrical characteristics, charge and discharge functions of the inductance component. The troubles mentioned above are the direction for the relevant manufacturers engaged in this industry to research and improve.

### SUMMARY OF THE INVENTION

The present invention has been accomplished under the circumstances in view. It is therefore the main object of the present invention to provide an inductor with coil conductor formed by conductive material, which is practical for mass production, has a low profile and requires less circuit board installation space. It is another object of the present invention to provide an inductor with coil conductor formed by conductive material, which ensures the manufacturing quality and yield, and achieves the effects of simple structure, ease of installation, high production efficiency and cost effectiveness.

To achieve these and other objects of the present invention, inductor with coil conductor formed by conductive material comprises an insulative plastic block, a plurality of magnetic conductive components and a connection carrier. The insulative plastic block comprises a block base defining a recessed open chamber in a top side thereof, a positioning unit comprising a plurality of U-shaped plates mounted in the recessed open chamber, and conductors respectively formed of an electroplated conductive adhesive on the positioning unit using laser direct structuring (LDS) and isolated from one another. Each conductor has two opposing leads respectively extended out of the block base. The magnetic conductive components each comprise a magnetic core mounted in the recessed open chamber of the block base. The magnetic core comprising a plurality of slots cut through opposing top and bottom sides thereof for receiving the U-shaped plates. Further, the magnetic conductive components are arranged in the recessed open chamber in such a manner that one lead of each conductor is disposed in one slot and the other lead of each conductor is disposed outside the magnetic cores. The connection carrier comprises a substrate, and a wire array located on the surface of the substrate. The wire array comprises a plurality of contact sets. Each contact set comprises two staggered rows of contacts, an input side electrically connected with a first contact of each contact set and an output side electrically connected with a last contact of each contact set. The contact sets incorporate with the conductors and the magnetic cores to form a plurality of coil circuits that form a magnetic induction effect.

Preferably, the insulative plastic block further comprises a plurality of partition plates mounted in the recessed open chamber and arranged in rows and dividing the recessed open chamber into a plurality of parallel channels. The positioning unit comprises a plurality of U-shaped plates mounted in the channels. The conductors are respectively formed on the U-shaped plates and isolated from one another. The magnetic cores of the magnetic conductive components are mounted in the recessed open chamber to force the U-shaped plates into the slots of the magnetic cores, enabling the conductors to be arranged side by side across the magnetic cores and the magnetic conductive components to be positioned between the insulative plastic block and the connection carrier.

Preferably, the U-shaped plates of the positioning unit have different width and depth and are alternatively mounted in the channels in such a manner that the internal width of the odd-numbered rows of U-shaped plates is larger than the internal width of the even-numbered rows of U-shaped plates and the vertical depth of the odd-numbered rows of U-shaped plates is larger than the vertical depth of the even-numbered rows of U-shaped plates. The conductors are respectively formed of an electroplated conductive adhesive on the U-shaped plates using laser direct structuring (LDS) and isolated from one another.

Preferably, the magnetic cores of the magnetic conductive component are selectively made of a conductive material or a non-conductive material. In one embodiment, the magnetic cores of the magnetic conductive component are made of a non-conductive material of a ferrite or ceramic material. The ferrite is classified as soft ferrite comprising manganese zinc ferrite (MnₐZn₍₁₋ₐ₎Fe₂O₄) and nickel zinc ferrite (NiₐZn₍₁₋ₐ₎Fe₂O₄), and hard ferrite comprising barium ferrite SrFe₁₂O₉(SrO.6Fe₂O₃), barium ferrite BaFe₁₂O₉(BaO.6Fe₂O₃) and cobalt ferrite CoFe₂O₄ (CoO.Fe₂O₃). In another embodiment, the magnetic cores of the magnetic conductive components are made of a conductive material selected from the group of iron, cobalt, zinc, nickel and alloys thereof. Further, each magnetic core has an insulating layer formed on the outer surface thereof.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique elevational view of an insulative plastic block for inductor with coil conductor formed by conductive material in accordance with a first embodiment of the present invention.

FIG. 2 is an exploded view of the inductor with coil conductor formed by conductive material in accordance with the first embodiment of the present invention.

FIG. 3 is a sectional front view of the inductor with coil conductor formed by conductive material in accordance with the first embodiment of the present invention.

FIG. 4 is an oblique elevational view of an insulative plastic block for inductor with coil conductor formed by conductive material in accordance with a second embodiment of the present invention.

FIG. 5 is an exploded view of the inductor with coil conductor formed by conductive material in accordance with the second embodiment of the present invention.

FIG. 6 is a sectional front view of the inductor with coil conductor formed by conductive material in accordance with the second embodiment of the present invention.

### DETAILED DESCRIPTION OF THE PREFERRED EMBODIMENT

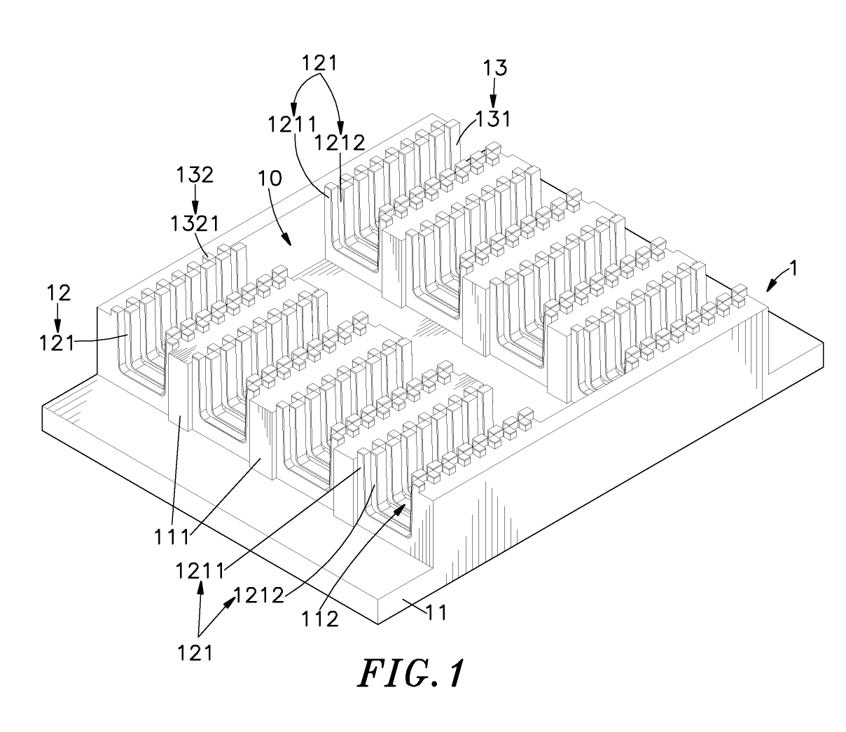

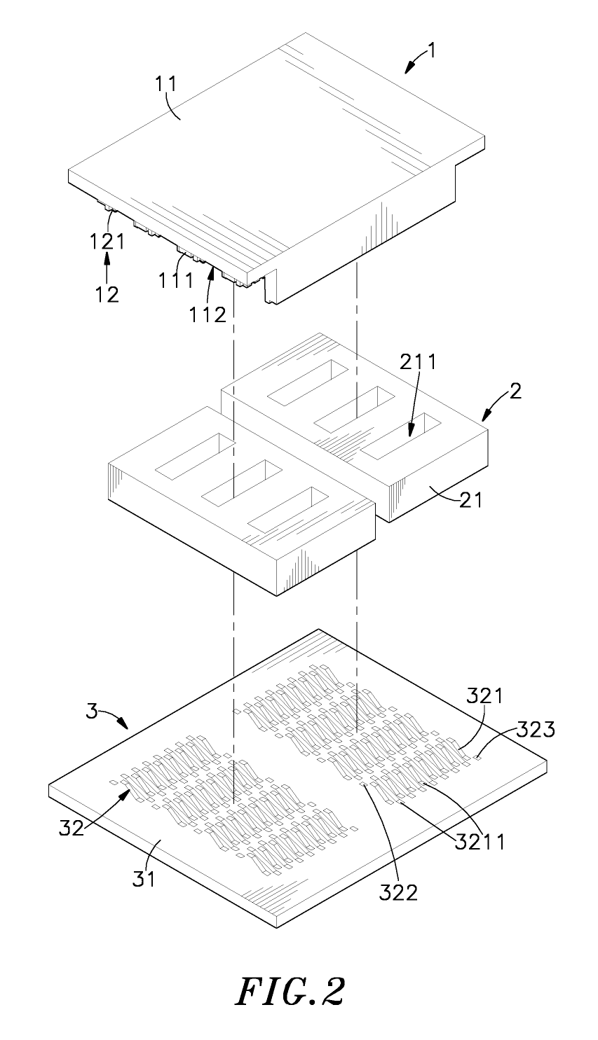

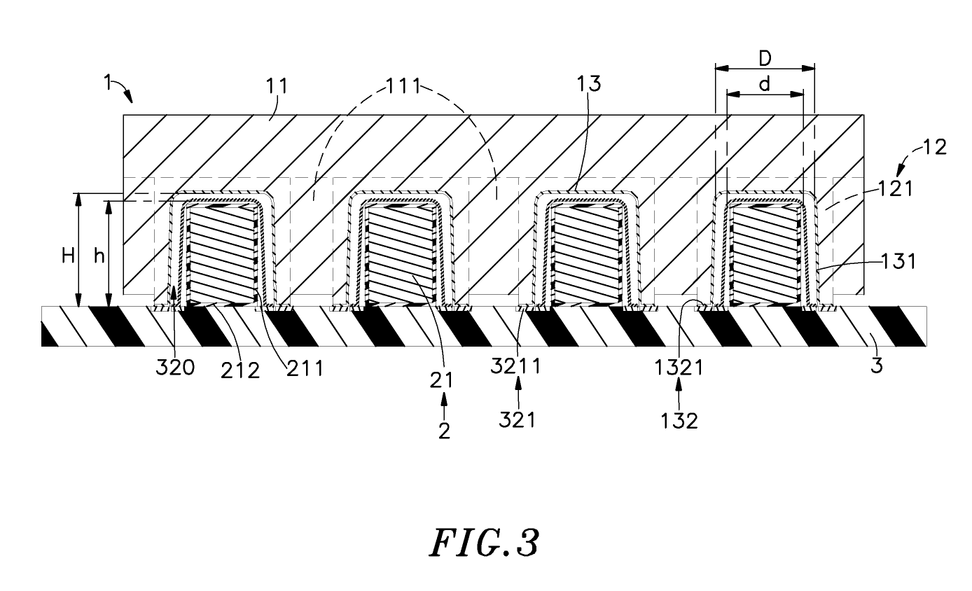

Referring to FIGS. 1-3, an inductor with coil conductor formed by conductive material in accordance with a first embodiment of the present invention is shown. As illustrated, the inductor with coil conductor formed by conductive material comprises an insulative plastic block 1, a plurality of magnetic conductive components 2 and a connection carrier 3.

The insulative plastic block 1 comprises a block base 11 made from a plastic material in one piece by injection molding and defining a recessed open chamber 10 in a top side thereof, a plurality of partition plates 111 mounted in the recessed open chamber 10 and arranged in rows or an array and dividing the recessed open chamber 10 into a plurality of parallel channels 112, a positioning unit 12 comprising a plurality of U-shaped plates 121 of different width and depth alternatively mounted in the channels 112 with respective opposite ends thereof protruding from the block base 11, and conductors 13 respectively formed of an electroplated conductive adhesive on the U-shaped plates 121 using laser direct structuring (LDS) and isolated from one another. Each conductor 13 has two opposing leads 131 respectively extended along the two opposite ends of the respective U-shaped plate 121 with respective end portions 132 thereof disposed outside the block base 11. Each end portion 132 provides a bonding surface 1321. The bonding surfaces 1321 of the end portions 132 of the leads 131 of the conductors 13 are disposed in a coplanar relationship.

The magnetic conductive components 2 each comprise a magnetic core 21 in, for example, rectangular shape. The magnetic core 21 comprises a plurality of slots 211 cut through opposing top and bottom sides thereof.

The connection carrier 3 comprises a substrate 31 selected from, but not limited to, the group of bakelite, fiberglass, plastic sheet, ceramic and prepregs, and a wire array 32 made of a copper foil and located on a surface of the substrate 31. The wire array 32 comprises a plurality of contact sets 321 each comprising two staggered rows of contacts 3211, an input side 322 electrically connected with the first contact of each contact set 321, and an output side 323 electrically connected with the last contact of each contact set 321.

In installation, put the magnetic cores 21 of the magnetic conductive components 2 in the recessed open chamber 10 in the block base 11 of the insulative plastic block 1 to force the U-shaped plates 121 of the positioning unit 12 into the slots 211 of the magnetic cores 21, enabling one lead 131 of each conductor 13 to be disposed in one slot 211 of one respective magnetic core 21 and the other lead 131 of each conductor 13 to be disposed outside the respective magnetic core 21. At this time, the bonding surfaces 1321 of the end portions 132 of the leads 131 of the conductors 13 are disposed outside the insulative plastic block 1 and the magnetic cores 21. Thus, the conductors 13 are arranged side by side, in a ring or array, across the magnetic cores 21. In this embodiment, the insulative plastic block 1 and the magnetic conductive components 2 are assembled at first. Further, when mounting the magnetic cores 21 in the block base 11, a glue dispensing technique is employed. However, in actual application, the assembly sequence may also be changed according to the manufacturing process or structural design. For example, the magnetic cores 21 of the magnetic conductive components 2 may be set on the connection carrier 3 first, and then assembled and soldered with the insulative plastic block 1. Once the insulative plastic block 1, the magnetic conductive components 2 and the connection carrier 3 are assembled, an inductor with coil conductor formed by conductive material in accordance with the first embodiment of the present invention is obtained.

In this first embodiment, set the insulative plastic block 1 and the magnetic conductive components 2 on the substrate 31 of the connection carrier 3 to abut the bonding surfaces 1321 of the end portions 132 of the leads 131 of the conductors 13 at the contacts 3211 of the contact sets 321 of the wire array 32 and the solder material (such as solder paste, solder balls or conductive adhesive), thereby forming a coplane. Then, employ surface-mount technology (SMT) to bond the leads 131 of the conductors 13 to the contact sets 321 of the wire array 32, thereby forming the desired inductor (transformer or any other inductance component). When an electric current is conducted to the input side 322 of the wire array 32, the electric current goes through the induction area 320 between the contacts 3211 of the contact sets 321 and the conductors 13 to an external circuit via the output side 323. Subject to the magnetic induction effect of the magnetic coil loop formed by the magnetic cores 21 of the magnetic conductive components 2, the inductor of the present invention provides stable inductive effect and rectifying characteristic. The coil structural design of the conductors 13 formed of an electroplated conductive adhesive on the positioning unit 12 of the insulative plastic block 1 using laser direct structuring (LDS) enables the dimension of the inductor to be minimized without increasing the overall height. Since the direction and density of the multiple conductors 13 can be precisely controlled according to actual needs, the inductance components can have the same or similar electrical characteristics to improve the manufacturing quality and yield, achieving the effects of simple structure, ease of installation, high production efficiency and cost effectiveness.

Further, the U-shaped plates 121 of the positioning unit 12 are respectively arranged in the channels 112 in the block base 11 of the insulative plastic block 1 in such a manner that the internal width “D” of the odd-numbered rows of U-shaped plates 1211 is larger than the internal width “d” of the even-numbered rows of U-shaped plates 1212; the vertical depth “H” of the odd-numbered rows of U-shaped plates 1211 is larger than the vertical depth “h” of the even-numbered rows of U-shaped plates 1212; the U-shaped plates 121 of different width and depth alternatively mounted in the channels 112 have the respective opposite ends thereof protruding from the block base 11 for a distance; the opposing leads 131 of the conductors 13 are respectively extended along the opposite ends of the respective U-shaped plated 121 with the respective end portions 132 disposed outside the block base 11 to keep the bonding surfaces 1321 in a coplanar relationship. Thus, the odd-numbered rows of U-shaped plates 1211 and the even-numbered rows of U-shaped plates 1212 are alternatively arranged in an array and respectively kept apart from one another at a distance. Further, the conductors 13 are respectively formed of an electroplated conductive adhesive on the U-shaped plates 121 using laser direct structuring (LDS) and isolated from one another. Thus, the conductors 13 on the U-shaped plates 121 in the recessed open chamber 10 of the block base 11 of the insulative plastic block 1, the contact sets 321 of the wire array 32 on the substrate 31 of the connection carrier 3 and the magnetic cores 21 of the magnetic conductive components 2 are assembled to constitute multiple sets of coil circuits that form a good induction effect.

Further, the conductors 13 are respectively formed of an electroplated conductive adhesive on the odd-numbered rows and even-numbered rows of U-shaped plates 121 using laser direct structuring (LDS). This is a 3D-MID (Three-dimensional molded interconnect device) manufacturing technology. Laser activation is employed. Through the activation of the laser beam, the surface tin anti-etch resist on each of the odd-numbered rows of U-shaped plate 1211 and the even-numbered rows of U-shaped plate 1212 is burned, and a physicochemical reaction is induced to form a metal core so that a rough surface is formed on each of the odd-numbered rows of U-shaped plate 1211 and the even-numbered rows of U-shaped plate 1212. Thus, the conductive material (which may be copper, zinc or nickel or its alloy material, etc.) is adhered to the rough surface of each of the odd-numbered rows of U-shaped plate 1211 and the even-numbered rows of U-shaped plate 1212 during metallization to form a conductive metal layer. Thereafter, metallization is conducted to conductive metal layer to form a 5˜8 μm circuit (copper, nickel. etc.). Thus, conductors 13 are respectively formed on each of the odd-numbered rows of U-shaped plate 1211 and the even-numbered rows of U-shaped plate 1212 and kept apart from one another.

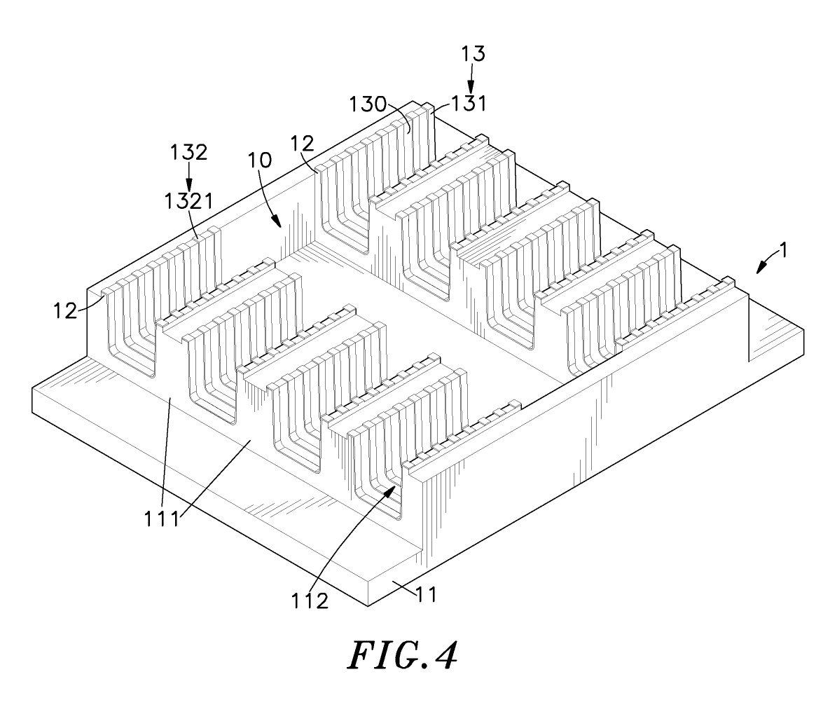

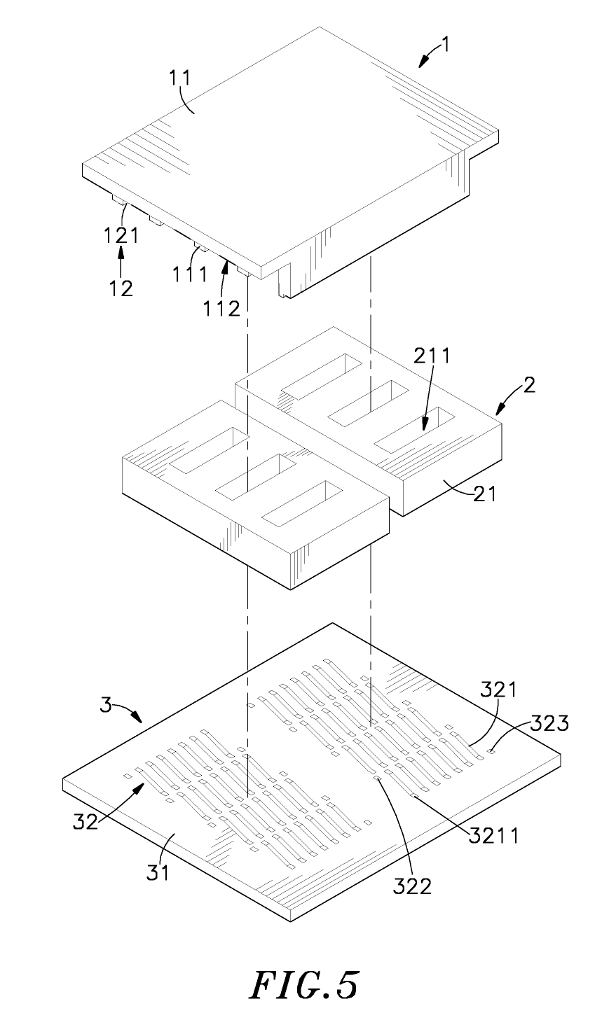

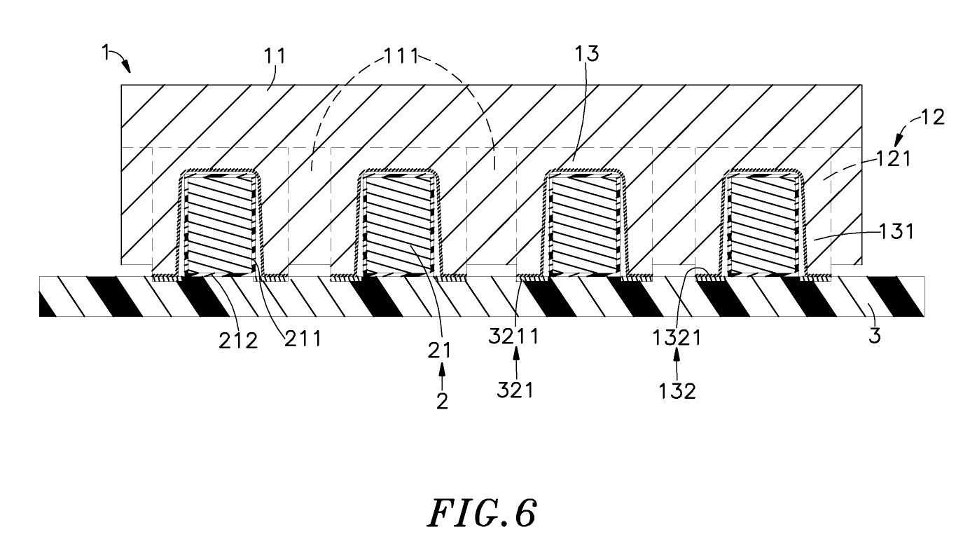

Referring to FIGS. 4-6, an inductor with coil conductor formed by conductive material in accordance with a second embodiment of the present invention is shown. As illustrated, the inductor with coil conductor formed by conductive material comprises an insulative plastic block 1, a plurality of magnetic conductive components 2 and a connection carrier 3.

The insulative plastic block 1 comprises a block base 11 made from a plastic material in one piece by injection molding and defining a recessed open chamber 10 in a top side thereof, a plurality of partition plates 111 mounted in the recessed open chamber 10 and arranged in rows or an array and dividing the recessed open chamber 10 into a plurality of parallel channels 112, a positioning unit 12 formed in each channel 112, and a conductor formed of an electroplated conductive adhesive on each positioning unit 12 using laser direct structuring (LDS). Then, remove part of the conductor 13 on each positioning unit 12 at a predetermined distance (for example, 1 mm, 1.5 mm, 2 mm, 2.5 mm or 3 mm, etc.) through the laser processing operation. Thus, the conductor 13 formed on the positioning unit 12 in each channel 112 is processed into U-shaped leads 131 and U-shaped grooves 130 that are alternatively arranged in each channel 112, and the end portions 132 of the leads 131 are respectively extended along the two opposite ends of the respective U-shaped plates 121 to the outside the block base 11. Each end portion 132 provides a bonding surface 1321. The bonding surfaces 1321 of the end portions 132 of the leads 131 of the conductors 13 are disposed in a coplanar relationship.

The magnetic conductive component 2 comprises one or more than one magnetic core 21 in, for example, rectangular shape. The magnetic core 21 comprises a plurality of slots 211 cut through opposing top and bottom sides thereof.

The connection carrier 3 comprises a substrate 31 selected from, but not limited to, the group of bakelite, fiberglass, plastic sheet, ceramic and prepregs, and a wire array 32 made of a copper foil and located on a surface of the substrate 31. The wire array 32 comprises a plurality of contact sets 321 each comprising two staggered rows of contacts 3211, an input side 322 electrically connected with the first contact of each contact set 321, and an output side 323 electrically connected with the last contact of each contact set 321.

In installation, put the magnetic cores 21 of the magnetic conductive components 2 in the channels 112 in the block base 11 of the insulative plastic block 1 to force the U-shaped plates 121 of the positioning unit 12 into the slots 211 of the magnetic cores 21, enabling one lead 131 of each conductor 13 to be disposed in one slot 211 of one respective magnetic core 21 and the other lead 131 of each conductor 13 to be disposed outside the respective magnetic core 21. At this time, the bonding surfaces 1321 of the end portions 132 of the leads 131 of the conductors 13 are disposed outside the insulative plastic block 1 and the magnetic cores 21. Thus, the conductors 13 are arranged side by side, in a ring or an array, across the magnetic cores 21. In this embodiment, the insulative plastic block 1 and the magnetic conductive components 2 are assembled at first. Further, when mounting the magnetic cores 21 in the block base 11, a glue dispensing technique is employed. However, in actual application, the assembly sequence may also be changed according to the manufacturing process or structural design. For example, the magnetic cores 21 of the magnetic conductive components 2 may be set on the connection carrier 3 first, and then assembled and soldered with the insulative plastic block 1. Once the insulative plastic block 1, the magnetic conductive components 2 and the connection carrier 3 are assembled, an inductor with coil conductor formed by conductive material in accordance with the second embodiment of the present invention is obtained.

In this second embodiment, set the insulative plastic block 1 and the magnetic conductive components 2 on the substrate 31 of the connection carrier 3 to abut the bonding surfaces 1321 of the end portions 132 of the leads 131 of the conductors 13 at the contacts 3211 of the contact sets 321 of the wire array 32 and the solder material (such as solder paste, solder balls or conductive adhesive), thereby forming a coplane. Then, employ surface-mount technology (SMT) to bond the leads 131 of the conductors 13 to the contact sets 321 of the wire array 32, thereby forming the desired inductor (transformer or any other inductance component). When an electric current is conducted to the input side 322 of the wire array 32, the electric current goes through the induction area 320 between the contacts 3211 of the contact sets 321 and the conductors 13 to an external circuit via the output side 323. Subject to the magnetic induction effect of the magnetic coil loop formed by the magnetic cores 21 of the magnetic conductive components 2, the inductor of the present invention provides stable inductive effect and rectifying characteristic.

The coil structural design of the conductors 13 formed of an electroplated conductive adhesive on the positioning unit 12 of the insulative plastic block 1 using laser direct structuring (LDS) and the laser technique to remove part of each conductor 13 for the formation of leads 131 and grooves 130 enable the dimension of the inductor to be minimized without increasing the overall height. Since the direction and density of the formation of the multiple conductors 13 and grooves 130 can be precisely controlled according to actual needs, the inductance components can have the same or similar electrical characteristics to improve the manufacturing quality and yield, achieving the effects of simple structure, ease of installation, high production efficiency and cost effectiveness.

Further, the magnetic cores 21 of the magnetic conductive components 2 in the above embodiments of the present invention may be made of a conductive material, and may be made of iron, cobalt, zinc, nickel or an alloy thereof, and an insulating layer 212 which can be an insulating varnish is formed on the outer surface of each magnetic core 21.

Further, the magnetic cores 21 of the magnetic conductive components 2 in the above embodiments of the present invention may also be made of a conductive material or a non-conductive material. In the case of non-conductive material, the magnetic cores 21 of the magnetic conductive components 2 can be made of a ferrite or ceramic material. Ferrite is generally a non-conductive ferrimagnetic ceramic material. Similar to other metal oxides, ferrite has high hardness and brittleness, and is classified as soft ferrite (soft magnet) and hard ferrite (hard magnet) according to its magnetic coercivity. Soft ferrite has a lower magnetic coercive force, and the magnetization of the material can be changed from positive to negative without consuming a lot of energy (hysteresis), and the high resistivity of the material itself can reduce energy loss, namely eddy current. The soft ferrite may include manganese zinc ferrite (MnₐZn₍₁₋ₐ₎Fe₂O₄) or nickel zinc ferrite (NiₐZn₍₁₋ₐ₎Fe₂O₄). The hard ferrite can be applied to a ferrite of a permanent magnet and has high magnetic coercivity and a remanence after magnetization. Hard ferrite is not easily demagnetized, but can generate magnetic flux, has high magnetic permeability, and can be called ceramic magnet. The hard ferrite includes barium ferrite [SrFe₁₂O₉(SrO.6Fe₂O₃)], barium ferrite [BaFe₁₂O₉(BaO.6Fe₂O₃)] or cobalt ferrite [CoFe₂O₄ (CoO.Fe₂O₃)], etc. The magnetic core 21 of the non-conductive material may not have an insulating layer 212 formed on the outer surface thereof.

As described above, the U-shaped positioning units 12 are mounted in the block base 11 of the insulative plastic block 1; the conductors 13 are formed of an electroplated conductive adhesive on the respective positioning units 12 using laser direct structuring (LDS); the conductor 13 on each positioning unit 12 is partially removed at a predetermined distance (for example, 1 mm, 1.5 mm, 2 mm, 2.5 mm or 3 mm, etc.) through a laser processing operation. Thus, the conductor 13 formed on the positioning unit 12 in each channel 112 is processed into U-shaped leads 131 and U-shaped grooves 130 that are alternatively arranged in each channel 112; the magnetic cores 21 of the magnetic conductive component 2 are mounted in the recessed open chamber 10 of the block base 11 for allowing insertion of the positioning units 12; the bonding surfaces 1321 of the end portions 132 of the leads 131 are respectively disposed inside the slots 211 and outside the magnetic cores 21; the insulative plastic block 1 and the magnetic conductive components 2 are respectively mounted on the connection carrier 3, enabling the bonding surfaces 1321 of the end portions 132 of the leads 131 to be respectively electrically bonded to the respective contacts 3211 of the contact sets 321 of the wire array 32 to form a continuous winding type magnetic induction coil circuit. The direction and density of the multiple conductors can be precisely controlled according to actual needs to ensure the manufacturing quality and yield, achieving the effects of simple structure, ease of installation, high production efficiency and cost effectiveness.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An inductor with coil conductor formed by conductive material, comprising:
an insulative plastic block comprising a block base defining a recessed open chamber in a top side thereof, a positioning unit comprising a plurality of U-shaped plates mounted in said recessed open chamber, and conductors respectively formed of an electroplated conductive adhesive on said positioning unit using laser direct structuring (LDS) and isolated from one another, each said conductor having two opposing leads respectively extended out of said block base;
a plurality of magnetic conductive components each comprising a magnetic core mounted in said recessed open chamber of said block base, said magnetic core comprising a plurality of slots cut through opposing top and bottom sides thereof for receiving said U-shaped plates, said magnetic conductive components being arranged in said recessed open chamber in such a manner that one said lead of each said conductor is disposed in one said slot and the other said lead of each said conductor is disposed outside said magnetic cores; and
a connection carrier comprising a substrate and a wire array located on a surface of said substrate, said wire array comprising a plurality of contact sets each comprising two staggered rows of contacts, an input side electrically connected with a first contact of each said contact set and an output side electrically connected with a last contact of each said contact set, said contact sets incorporating with said conductors and said magnetic cores to form a plurality of coil circuits that form a magnetic induction effect.

2. The inductor with coil conductor formed by conductive material as claimed in claim 1, wherein said insulative plastic block further comprises a plurality of partition plates mounted in said recessed open chamber and arranged in rows and dividing said recessed open chamber into a plurality of parallel channels; said positioning unit comprises a plurality of U-shaped plates mounted in said channels; said conductors are respectively formed on said U-shaped plates and isolated from one another; said magnetic cores of said magnetic conductive components are mounted in said recessed open chamber in said block base of said insulative plastic block to force said U-shaped plates of said positioning unit into said slots of said magnetic cores, enabling said conductors to be arranged side by side across said magnetic cores and said magnetic conductive components to be positioned between said insulative plastic block and said connection carrier.

3. The inductor with coil conductor formed by conductive material as claimed in claim 2, wherein said U-shaped plates of said positioning unit have different width and depth and are alternatively mounted in said channels in said block base of said insulative plastic block in such a manner that an internal width of the odd-numbered rows of said U-shaped plates is larger than an internal width of the even-numbered rows of said U-shaped plates and a vertical depth of the odd-numbered rows of said U-shaped plates is larger than a vertical depth of the even-numbered rows of said U-shaped plates; said conductors are respectively formed of an electroplated conductive adhesive on said U-shaped plates using laser direct structuring (LDS) and isolated from one another.

4. The inductor with coil conductor formed by conductive material as claimed in claim 3, wherein said conductors are respectively formed of an electroplated conductive adhesive on the odd-numbered rows of said U-shaped plates and the even-numbered rows of said U-shaped plates using laser direct structuring (LDS) so that said conductors incorporate with said contact sets and said magnetic cores to form a plurality of coil circuits that form a magnetic induction effect.

5. The inductor with coil conductor formed by conductive material as claimed in claim 2, wherein said U-shaped plates have respective opposite ends thereof protruding from said block base; conductors each have the two opposing said leads respectively extended along the two opposite ends of the respective said U-shaped plate with respective end portions thereof disposed outside said block base, each said end portion providing a bonding surface, the said bonding surfaces of said end portions of said leads of said conductors being disposed in a coplanar relationship.

6. The inductor with coil conductor formed by conductive material as claimed in claim 5, wherein said bonding surfaces of said leads of said conductors are abutted at said contacts of said contact sets of said wire array and said leads of said conductors are bonded to said contact sets of said wire array using surface-mount technology (SMT).

7. The inductor with coil conductor formed by conductive material as claimed in claim 1, wherein said magnetic cores of said magnetic conductive component are selectively made of a conductive material or a non-conductive material.

8. The inductor with coil conductor formed by conductive material as claimed in claim 7, wherein said magnetic cores of said magnetic conductive component are made of a non-conductive material of a ferrite or ceramic material, said ferrite being classified as soft ferrite comprising manganese zinc ferrite (MnₐZn₍₁₋ₐ₎Fe₂O₄) and nickel zinc ferrite (NiₐZn₍₁₋ₐ₎Fe₂O₄), and hard ferrite comprising barium ferrite SrFe₁₂O₉(SrO.6Fe₂O₃), barium ferrite BaFe₁₂O₉(BaO.6Fe₂O₃) and cobalt ferrite CoFe₂O₄ (CoO.Fe₂O₃).

9. The inductor with coil conductor formed by conductive material as claimed in claim 7, wherein said magnetic cores of said magnetic conductive components are made of a conductive material selected from the group of iron, cobalt, zinc, nickel and alloys thereof, each said magnetic core having an insulating layer formed on the outer surface thereof.

10. An inductor with coil conductor formed by conductive material, comprising:
an insulative plastic block comprising a block base defining a recessed open chamber in a top side thereof, a plurality of U-shaped positioning units mounted in said recessed open chamber and a plurality of conductors respectively formed of a conductive material on said U-shaped positioning units, each said conductor being processed into U-shaped leads and U-shaped grooves that are alternatively arranged in the respective said channel, each said U-shaped lead having respective bonding surfaces of opposite end portions thereof extended outside said block base;
a plurality of magnetic conductive components each comprising a magnetic core mounted in said recessed open chamber of said block base, said magnetic core comprising a plurality of slots cut through opposing top and bottom sides thereof for receiving said U-shaped positioning units, said magnetic conductive components being arranged in said recessed open chamber in such a manner that one said lead of each said conductor is disposed in one said slot and the other said lend of each said conductor is disposed outside said magnetic cores; and
a connection carrier comprising a substrate and a wire array located on a surface of said substrate, said wire array comprising a plurality of contact sets each comprising two staggered rows of contacts, an input side electrically connected with a first contact of each said contact set and an output side electrically connected with a last contact of each said contact set, said contact sets incorporating with said conductors and said magnetic cores to form a plurality of coil circuits that form a magnetic induction effect.

11. The inductor with coil conductor formed by conductive material as claimed in claim 10, wherein said insulative plastic block further comprises a plurality of partition plates mounted in said recessed open chamber and arranged in rows and dividing said recessed open chamber into a plurality of parallel channels; said U-shaped positioning units are respectively mounted in said channels; said conductors are respectively formed on said U-shaped positioning units and isolated from one another; said conductors are formed of an electroplated conductive adhesive on the respective said U-shaped positioning units using laser direct structuring (LDS) and isolated from one another; said magnetic cores of said magnetic conductive components are mounted in said recessed open chamber in said block base of said insulative plastic block to force said U-shaped positioning units into said slots of said magnetic cores, enabling said conductors to be arranged side by side across said magnetic cores and said magnetic conductive components to be positioned between said insulative plastic block and said connection carrier.

12. The inductor with coil conductor formed by conductive material as claimed in claim 11, wherein said conductor on each said U-shaped positioning unit is partially removed through a laser processing operation so that each said conductor is processed into a plurality of said U-shaped leads and said U-shaped grooves that are alternatively arranged in each said channel at a distance of 1 mm, 1.5 mm, 2 mm, 2.5 mm or 3 mm, each said lead having opposite end portions thereof disposed outside said block base, each said end portion providing a bonding surface, the said bonding surfaces of said end portions of said leads being disposed in a coplanar relationship, said leads incorporating with said contact sets and said magnetic cores to form a plurality of coil circuits that form a magnetic induction effect.

13. The inductor with coil conductor formed by conductive material as claimed in claim 12, wherein said bonding surfaces of said leads of said conductors are abutted at said contacts of said contact sets of said wire array and said leads of said conductors are bonded to said contact sets of said wire array using surface-mount technology (SMT).

14. The inductor with coil conductor formed by conductive material as claimed in claim 10, wherein said magnetic cores of said magnetic conductive component are selectively made of a conductive material or a non-conductive material.

15. The inductor with coil conductor formed by conductive material as claimed in claim 14, wherein said magnetic cores of said magnetic conductive component are made of a non-conductive material of a ferrite or ceramic material, said ferrite being classified as soft ferrite comprising manganese zinc ferrite (MnₐZn₍₁₋ₐ₎Fe₂O₄) and nickel zinc ferrite (NiₐZn₍₁₋ₐ₎Fe₂O₄), and hard ferrite comprising barium ferrite SrFe₁₂O₉(SrO.6Fe₂O₃), barium ferrite BaFe₁₂O₉(BaO.6Fe₂O₃) and cobalt ferrite CoFe₂O₄ (CoO.Fe₂O₃).

16. The inductor with coil conductor formed by conductive material as claimed in claim 14, wherein said magnetic cores of said magnetic conductive components are made of a conductive material selected from the group of iron, cobalt, zinc, nickel and alloys thereof, each said magnetic core having an insulating layer formed on the outer surface thereof.
